(19) United States
(12) Patent Application Publication
(10) Pub. No.: US 2016/0321448 A1
(43) Pub. Date: Nov. 3, 2016

(54) KEYBOARD AND CONTROL METHOD THEREOF

(71) Applicants: DARFON ELECTRONICS (SUZHOU) CO., LTD., Jiangsu Province (CN); Darfon Electronics Corp., Taoyuan City (TW)

(72) Inventors: Te-Ping Hsu, Taoyuan City (TW); Tzu-Pang Chiang, Toayuan City (TW)

(73) Assignees: DARFON ELECTRONICS (SUZHOU) CO., LTD., Jiangsu Province (CN); Darfon Electronics Corp., Taoyuan City (TW)

(21) Appl. No.: 15/140,612

(22) Filed: Apr. 28, 2016

(30) Foreign Application Priority Data
Apr. 30, 2015 (TW) 104113877
May 8, 2015 (TW) 104114697

(51) Int. Cl. G06F 21/44; G06F 21/57

(52) U.S. Cl. CPC G06F 21/44; G06F 21/57

(57) ABSTRACT

A keyboard wirelessly connecting to one of multiple hosts is provided. Each host has a device ID code and a device authorization code. The keyboard includes a host selection device, a storage device, a connection device, and a communication device. The storage device stores a lookup table including multiple host codes, each corresponding to one device ID code and one device authorization code. The host selection device selects a candidate host code when receiving a first operation. The connection device receives a second operation different from the first operation. When the second operation lasts shorter than a threshold period, the keyboard connects to a host having the device ID code and the device authorization code corresponding to the candidate host code. When the second operation lasts longer than the threshold period, the keyboard updates the device ID code and the device authorization code corresponding to the candidate host code.

This application claims the benefits of Taiwan application Serial No. 104113877, filed Apr. 30, 2015, and Taiwan application Serial No. 104114697, filed May 8, 2015, the subject matters of which are incorporated herein by reference.

### BACKGROUND OF THE INVENTION

1. Field of the Invention

The invention relates in general to a keyboard, and more particularly to a keyboard capable of controlling multiple hosts.

2. Description of the Related Art

With the rapid technology progress, several technology products have been widely used in modern life, including desktop computers, laptop computers, tablet computers, smart phones, etc. Because the limited size of the mobile phone, it is not easy for users to input text. One possible approach is to use a computer keyboard with wireless connection capability. The computer keyboard can control the mobile phone through wireless data transmission. In addition, nowadays a user may possess more than one tablet computers and smart phones. Thus, it is an important subject in the industry to provide a user friendly keyboard that is capable of connecting to multiple hosts and controlling multiple hosts.

### SUMMARY OF THE INVENTION

The invention is directed to a keyboard capable of wirelessly connecting to one of multiple hosts and the control method thereof.

According to a first aspect of the present invention, a keyboard is provided. The keyboard is capable of wirelessly connecting to one of multiple hosts. Each host has a device identification (ID) code and a device authorization code. The keyboard includes a host selection device, a storage device, a connection device, and a communication device. The storage device stores a lookup table, wherein the lookup table includes multiple host codes, each host code corresponding to one of the device ID codes and one of the device authorization codes. The host selection device selects one of the host codes as a candidate host code when receiving a first operation, and one of the hosts, whose device ID code and device authorization code corresponding to the candidate host code, being designated as a candidate host. The connection device is capable of receiving a second operation, wherein the first operation is different from the second operation. The communication device is capable of wirelessly connecting the keyboard to the candidate host. When the second operation lasts shorter than a threshold period, the keyboard wirelessly connects to one of the hosts having the device ID code and the device authorization code corresponding to the candidate host code. When the second operation lasts longer than the threshold period, the keyboard updates the device ID code and the device authorization code corresponding to the candidate host code.

According to a second aspect of the present invention, a keyboard is provided. The keyboard is capable of wirelessly connecting to one of multiple hosts. Each host has a device ID code and a device authorization code, and executes an operating system (OS). Each operating system is represented by an OS ID code. The keyboard includes multiple host selection keys, multiple OS selection keys, a storage device, a connection device, and a communication device. The storage device stores a lookup table, wherein the lookup table includes multiple host codes, each host code corresponding to one of the OS ID codes, one of the device ID codes, and one of the device authorization codes. The host selection keys select one of the host codes as a candidate host code, and one of the hosts, whose device ID code and device authorization code corresponding to the candidate host code, being designated as a candidate host. The OS selection keys select one of multiple OS ID codes as a candidate OS ID code. The communication device is capable of wirelessly connecting the keyboard to the candidate host. When one of the host selection keys is first triggered and then the connection device is triggered next, the keyboard wirelessly connects to one of the hosts having the device ID code and the device authorization code corresponding to the candidate host code. When one of the OS selection keys is first triggered and then the connection device is triggered next, the keyboard wirelessly connects to one of the hosts having the device ID code and the device authorization code corresponding to the candidate OS ID code.

According to a third aspect of the present invention, a keyboard control method is provided. The control method includes the following steps. Providing a keyboard capable of wirelessly connecting to one of multiple hosts. The keyboard includes multiple host selection keys, multiple OS selection keys, a storage device, a connection device, and a communication device. Each host executes an OS, and has a device ID code and a device authorization code. Each operating system is represented by an OS ID code. Storing a lookup table by the storage device, wherein the lookup table includes multiple host codes, each of the host codes corresponding to one of the OS ID codes, one of the device ID codes, and one of the device authorization codes. Selecting, by the host selection keys, one of the host codes as a candidate host code, and one of the hosts, whose device ID code and device authorization code corresponding to the candidate host code, being designated as a candidate host. Selecting, by the OS selection keys, one of the OS ID codes as a candidate OS ID code. Wirelessly connecting, by the communication device, the keyboard to the candidate host. When one of the host selection keys is first triggered and then the connection device is triggered next, the keyboard wirelessly connects to one of the hosts having the device ID code and the device authorization code corresponding to the candidate host code. When one of the OS selection keys is triggered first and then the connection device is triggered next, the keyboard wirelessly connects to one of the hosts having the device ID code and the device authorization code corresponding to the candidate OS ID code.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a diagram of a keyboard capable of controlling multiple hosts.

FIG. 2 shows a diagram of a keyboard according to an embodiment of the invention.

FIG. 3 shows a diagram of a keyboard according to an embodiment of the invention.

FIG. 4A shows a diagram of using a knob button as the host selection device.

FIG. 4B shows a diagram of using a slide switch as the host selection device.

FIG. 4C shows a diagram of using multiple keys as the host selection device.

FIG. 4D shows a diagram of using a combination of keys as the host selection device.

FIG. 5 shows a diagram of a keyboard according to an embodiment of the invention.

FIG. 6 shows a configuration diagram of a keyboard with indication lights according to an embodiment of the invention.

FIG. 7 shows a flowchart of a keyboard control method according to an embodiment of the invention.

FIG. 8 shows a flowchart of a keyboard control method according to an embodiment of the invention.

FIG. 9 shows a flowchart of a keyboard control method according to an embodiment of the invention.

FIG. 10A and FIG. 10B show flowcharts of a keyboard control method according to an embodiment of the invention.

FIG. 11A shows a diagram of a keyboard broadcasting connection message according to an embodiment of the invention.

FIG. 11B shows a diagram of a keyboard receiving connection response message according to an embodiment of the invention.

FIG. 11C shows a diagram of a keyboard broadcasting end display message according to an embodiment of the invention.

FIG. 12 shows a flowchart of a keyboard control method according to an embodiment of the invention.

FIG. 13 shows a flowchart of a keyboard control method according to an embodiment of the invention.

FIG. 14 shows a flowchart of a control method at the keyboard according to an embodiment of the invention.

FIG. 15 shows a flowchart of a control method at the host according to an embodiment of the invention.

FIG. 16 shows a diagram of a connection response window according to an embodiment of the invention.

### DETAILED DESCRIPTION OF THE INVENTION

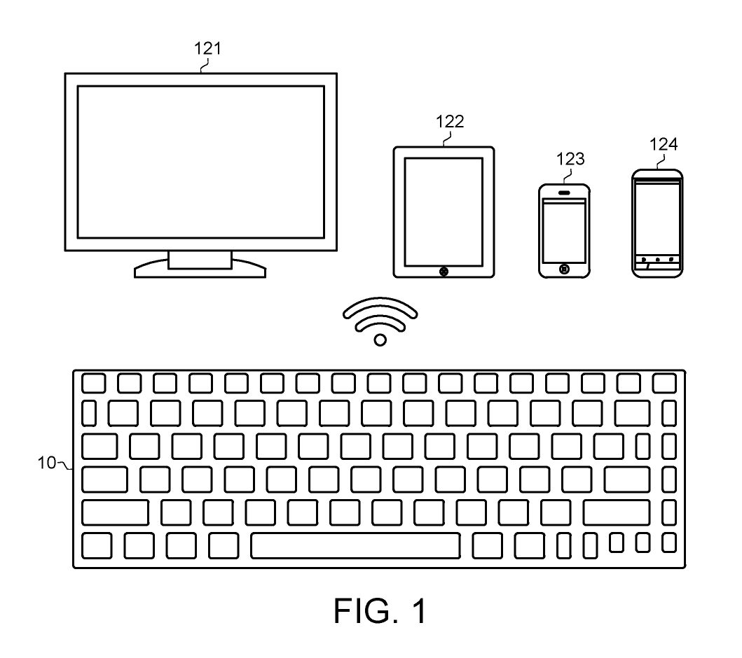

FIG. 1 shows a diagram of a keyboard 10 capable of controlling multiple hosts 121-124. As shown in FIG. 1, the keyboard 10 may wirelessly connect to one of multiple hosts 121-124 such that a user may control multiple hosts 121-124 with the keyboard 10. The hosts may include a desktop computer 121, a tablet computer 122, a smart phone 123, and a smart phone 124. The user may control the keyboard 10 to switch between the hosts 121-124 to select one of the hosts to be controlled. The wireless connection between the keyboard 10 and the hosts 121-124 may be infrared transmission, Bluetooth protocol, ZigBee protocol, wireless USB, or similar wireless transmission technologies. The keyboard 10 is able to switch to control multiple hosts 121-124 through wireless signal transmission. Embodiments regarding the keyboard capable of controlling multiple hosts and the control method thereof are disclosed in the following description.

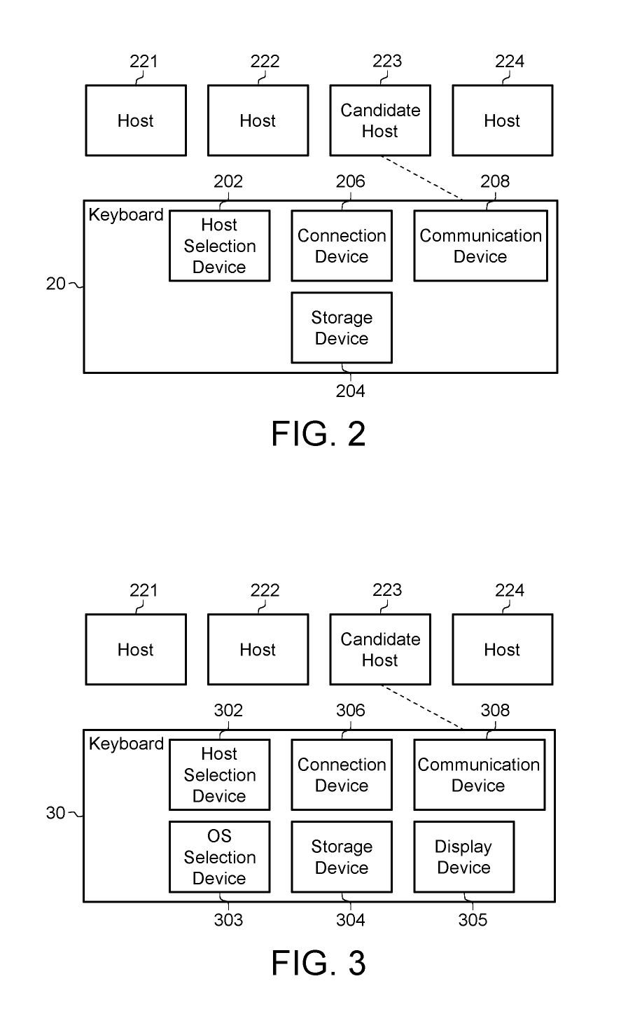

FIG. 2 shows a diagram of a keyboard 20 according to an embodiment of the invention. The keyboard 20 is capable of wirelessly connecting to one of multiple hosts 221-224. Each of the hosts 221-224 has a device ID code and a device authorization code. The keyboard 20 includes a host selection device 202, a storage device 204, a connection device 206, and a communication device 208. The storage device 204 stores a lookup table LUT2, wherein the lookup table LUT2 includes multiple host codes. Each host code is corresponding to one of the device ID codes and one of the device authorization codes. The host selection device 202 selects one of the host codes as a candidate host code when receiving a first operation, and one of the hosts 221-224, whose device ID code and device authorization code corresponding to the candidate host code, being designated as a candidate host 223. The connection device 206 is capable of receiving a second operation, wherein the first operation is different from the second operation. The communication device 208 is capable of wirelessly connecting the keyboard 20 to the candidate host 223. When the second operation lasts shorter than a threshold period Tp, the keyboard 20 wirelessly connects to one of the hosts 221-224 having the device ID code and the device authorization code corresponding to the candidate host code. When the second operation lasts longer than the threshold period Tp, the keyboard 20 updates the device ID code and the device authorization code corresponding to the candidate host code.

The hosts 221-224 may be for example tablet computers or smart phones or the like. The keyboard 20 may be paired with and wirelessly connected to the hosts 221-224 through Bluetooth signal to switch to control the hosts 221-224. The communication device 208 is configured to transmit and receive Bluetooth control signals.

In the initial state the keyboard 20 does not store any host related information. After pairing with individual host 221-224, the related information of the hosts 221-224 may be stored in the storage device 204 of the keyboard 20. The storage device 204 may be implemented by non-volatile memory. The storage device 204 may store the device ID code and the device authorization code of the host in a lookup table LUT2. The lookup table LUT2 records a host code and the corresponding device ID code and the device authorization code. After the pairing process, the keyboard 20 can switch to control the hosts 221-224 according to the lookup table LUT2. An example of the lookup table LUT2 is shown in Table 1 below.

TABLE 1

| | | | Device Authorization |
|---|---|---|---|
| | Host Code | Device ID Code | Code |
| Host 221 | #1 | ABC | 1111 |
| Host 222 | #2 | XXX | 2222 |
| Host 223 | #3 | YYY | 3000 |
| Host 224 | #4 | ZZZ | 4567 |

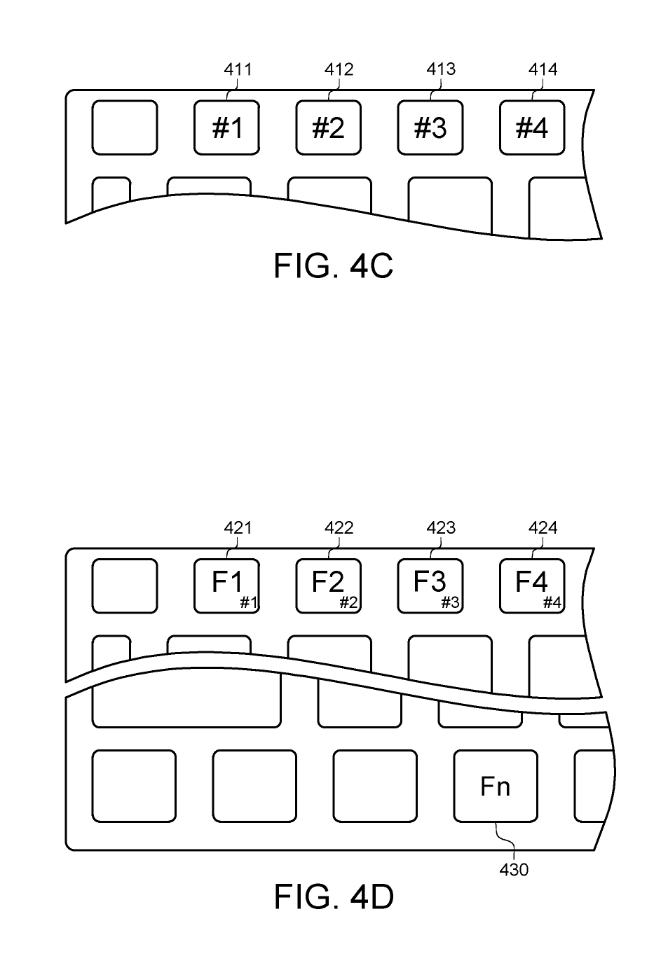

The user may select which host code to be paired with the current host or which host to be controlled by the host selection device 202. The host selection device 202 may be disposed on the keyboard 20 just like general keys. The host selection device 202 provides the user selection capability, whereas the specific implementation of the host selection device 202 is not limited thereto. Some possible implementations of the host selection device 202 are shown in FIG. 4A-FIG. 4D. FIG. 4A shows a knob button 401. The knob button 401 may be rotated by the user such that the mark on the knob button 401 points toward different host codes #1-#5. FIG. 4B shows a slide switch 402, which may be moved or slid by the user such that the position of the slide switch 402 is at different locations corresponding to different host codes #1-#5. FIG. 4C shows a diagram of using multiple keys 411-414 as the host selection device. When the user presses different keys 411-414, different host codes #1-#4 may be selected. FIG. 4D shows a diagram of using a combination of keys as the host selection device. In this way the original keys on the keyboard may be utilized to fulfill the host selection device 202. For example, by pressing the auxiliary function key Fn 430 and the function key F1-F4 421-424 in combination, different host codes #1-#4 may be selected.

The connection device 206 is for example a key. Depending on the time that the connection device 206 is triggered, either a pairing operation or a switching connection operation is performed. For example, when the time that the connection device 206 is pressed is longer than a threshold period Tp (such as 3 seconds), the pairing operation is performed. On the other hand, when the pressing time is shorter than or equal to the threshold period Tp, the switching connection operation is performed. The two operations are described in detail below.

The pairing operation: this operation enables the keyboard 20 to recognize the host to be paired, and to store the host related information in the keyboard 20. For example, a user attempts to pair a mobile phone P1 (with device ID code HHH, device authorization code 5678) to the host code #3 of the keyboard 20. First, the host selection device 202 is switched to the host code #3, which may be accomplished by rotating, sliding, or key pressing, such as the examples shown in FIG. 4A-FIG. 4D. Next, the connection device 206 is long pressed (with the pressing time greater than the threshold period Tp) to start the pairing operation of the keyboard 20. The communication device 208 transmits and receives Bluetooth pairing signals to accomplish the Bluetooth pairing process with the mobile phone P1. The storage device 204 updates the device ID code and the device authorization code corresponding to the host code #3 in the lookup table LUT2 to HHH and 5678 respectively. The information related to the mobile phone P1 is thus stored in the field of host code #3 of the lookup table LUT2.

Switching connection operation: after the keyboard 20 has stored information related to multiple hosts, the user may switch to control different hosts. For example, the user wants to switch to control the tablet computer P2. The information related to the tablet computer P2 is recorded at the host code #2 in the lookup table LU2. First, the host selection device 202 is switched to the host code #2, which may be accomplished by rotating, sliding, or key pressing, such as the examples shown in FIG. 4A-FIG. 4D. Next, the connection device 206 is short pressed (with the pressing time less than or equal to the threshold period Tp) to start the switching connection operation. The keyboard 20 reads the device ID code and the device authorization code corresponding to the host code #2 in the lookup table LUT2 to obtain the related information of the connection target. The communication device 208 transmits Bluetooth control signal, such that the keyboard 20 wirelessly connects to the tablet computer P2 to control the tablet computer P2.

It should be noted that in the above examples, either in the pairing operation or in the switching connection operation, the method includes the first step of triggering the host selection device 202 and the second step of triggering the connection device 206. After the first step of triggering the host selection device 202, the communication device 208 does not transmit any Bluetooth control signal. That is, neither the connection status nor the internally stored pairing status of the keyboard 20 changes after performing only the first step. The second step of triggering the connection device 206 has to be performed, and then the communication device 208 starts to transmit the related Bluetooth control signal for the pairing operation or the switching connection operation. In this way, accidental mistake operation from the user may be avoided, and also power consumption may be reduced effectively.

For example, when the user wants to switch to the host code #3 but accidentally switches to the host code #4, the Bluetooth control signal is not transmitted to the host corresponding to the host code #4. The user can correct the mistake by switching to the host code #3 and then trigger the connection device 206. The Bluetooth control signal is transmitted only after the connection device 206 is triggered. Take the knob button 401 in FIG. 4A as example, when switching from the host code #1 to the host code #5, the mark of the knob button 401 moves past the host codes #2-#4. During this moving process, no redundant Bluetooth control signals are transmitted to the hosts corresponding to the host codes #2-#4. The Bluetooth control signal is transmitted to the host corresponding to the host code #5 only after the connection device 206 is triggered. As such, by utilizing the two-step operation method in this disclosure, including the first step of triggering the host selection device 202 and the second step of triggering the connection device 206, redundant Bluetooth control signal transmission can be avoided to reduce power consumption. In addition, incorrect connection configuration caused by user's accidental mistake operation or instantaneous switching state during the user's operation process can be avoided.

The connection device 206 may be implemented in various ways, for example, an independent key disposed on the keyboard 20. The connection device 206 may also be integrated to the host selection device 202, such as implemented by the knob button 401 shown in FIG. 4A. The knob button 401 may be rotated horizontally and pressed vertically. Different host codes may be selected by rotating the knob button 401 such that the mark points toward different locations. The connection device 206 may be triggered by pressing the knob button 401 vertically. Similarly, the slide switch 402 shown in FIG. 4B may also be a button that can be pressed vertically, which may trigger the connection device 206 when being pressed. In still other implementations, the keyboard 20 includes a keyboard body, which includes a keyboard mechanical body and multiple keys (such as general keys for English letters). The connection device 206 may be implemented by any of these keys. That is, after the host selection device 202 is triggered, the connection device 206 may be triggered when the user presses any key on the keyboard 20, enabling the communication device 208 to transmit Bluetooth control signal.

In the above examples, the first operation of triggering the host selection device 202 has to be different from the second operation of triggering the connection device 206, such as different operation gestures, different operation times, or different operation locations. According to the examples given above, when the host selection device 202 and the connection device are different keys, the first operation and the second operation correspond to pressing keys at different locations. When the host selection device 202 and the connection device 206 are integrated together, such as the knob button 401 shown in FIG. 4A, the first operation may be horizontally rotating the knob button 401, and the second operation may be vertically pressing the knob button 401. Because of the different first operation and second operation, the first step of selecting a host and the second step of establishing connection (or pairing) can be clearly distinguished, such that accidental mistake operation from the user may be avoided, and also power consumption may be reduced effectively.

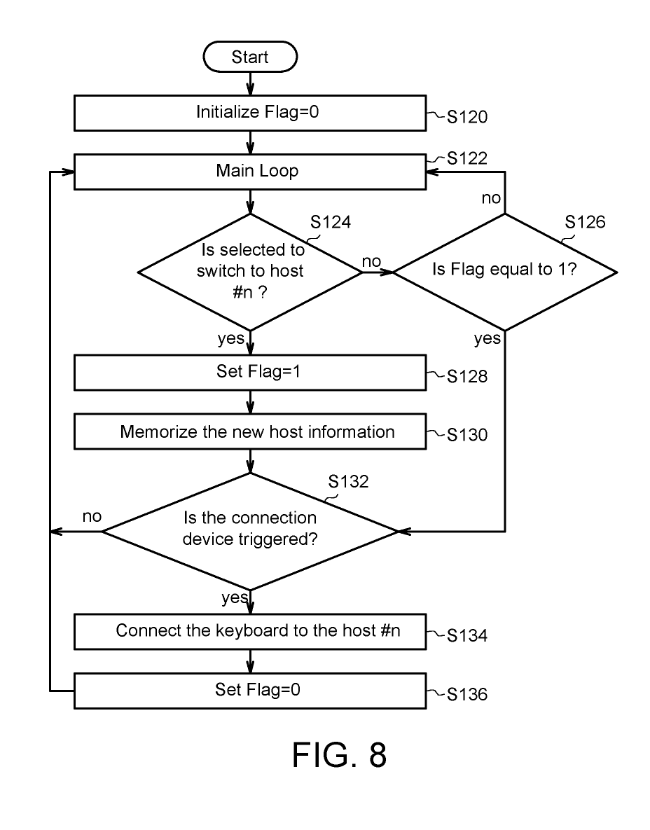

The control method of this embodiment may be referred to FIG. 7. The method includes the following steps. Step S102: Store a lookup table by the storage device. The lookup table includes multiple host codes. Each host code is corresponding to one of the device ID codes and one of the device authorization codes. Step S104: Select one of the host codes by the host selection device as a candidate host code when receiving a first operation, and one of the hosts, whose device ID code and device authorization code corresponding to the candidate host code, being designated as a candidate host. Step S106: Receive a second operation by the connection device. Step S108: Determine whether or not the second operation lasts longer than a threshold period? If no, the switching connection operation in step S110 is performed. Step S110: The keyboard wirelessly connects to one of the hosts having the device ID code and the device authorization code corresponding to the candidate host code. If yes, the pairing operation in step S112 is performed. Step S112: The keyboard updates the device ID code and the device authorization code corresponding to the candidate host code.

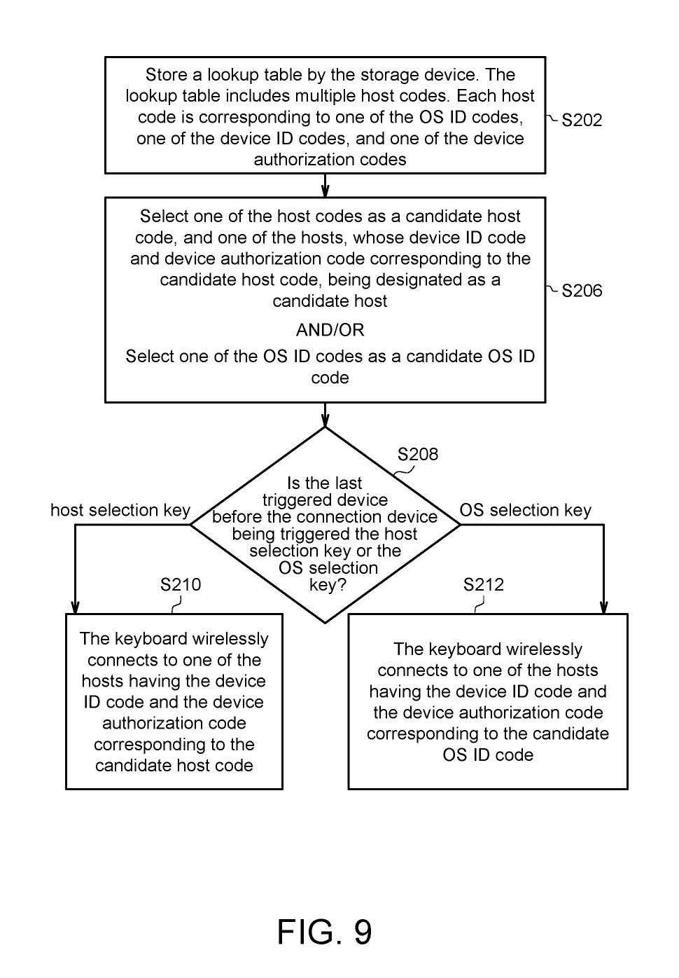

As for the switching connection operation, FIG. 8 shows a flowchart of a keyboard control method according to an embodiment of the invention. The keyboard 20 has a Flag indicating the internal control state. In step S120, Flag is initialized to 0. Flag equal to 0 represents that no switching operation is to be performed. Flag equal to 1 represents preparing for switching. Step S122 is the main loop, which is a loop for normal control flow when the keyboard 20 is operated in a normal condition (not going to perform switching operation). Step S124 determines whether or not the user selects to switch to the host #m, such as switching by triggering the host selection device 202. If not, step S126 is performed to check the Flag value. If yes, step S128 is performed to set Flag to 1. Step S130 memorizes the newly selected host information to prepare for the switching operation. Step S132 determines whether the user triggers the connection device 206 or not. If not, the flow jumps back to the step S122 (Flag value is kept as 1). If yes, step S134 is performed to connect the keyboard 20 to the host #m. The connection is for example accomplished by reading the device ID code and the device authorization code corresponding to the host code #m in the lookup table LUT2. Step S136 restores the Flag to 0, and then the control flow goes back to the main loop in step S122.

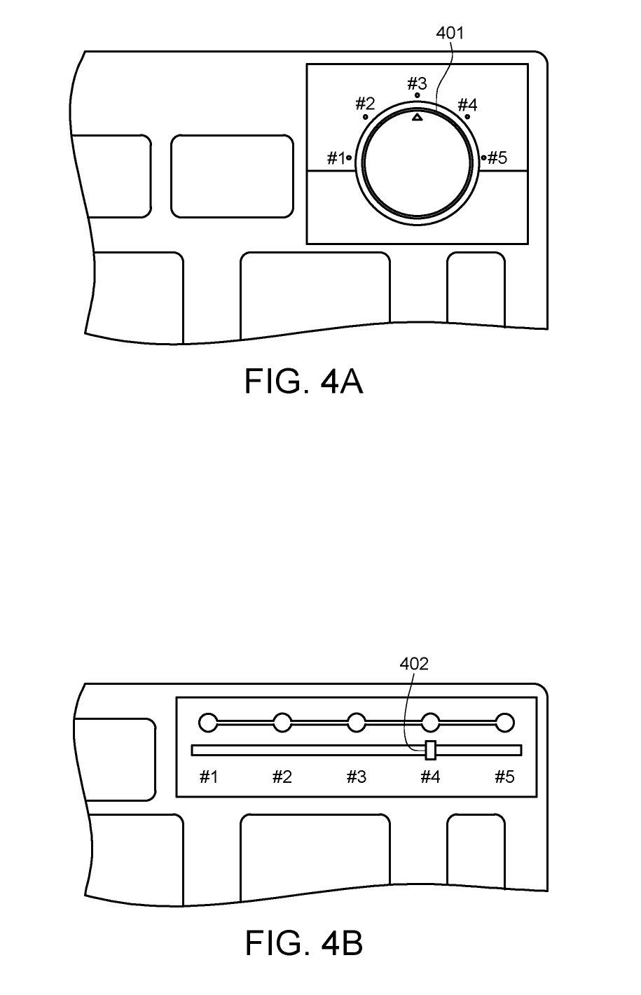

FIG. 3 shows a diagram of a keyboard 30 according to an embodiment of the invention. As compared to the keyboard 20 in FIG. 2, the keyboard 30 further includes an operating system (OS) selection device 303 and a display device 305. These two devices may be optionally disposed, or alternatively only one of these two devices may be disposed on the keyboard 20. The OS selection device 303 allows the user to select one of the hosts to be controlled by selecting the OS. The lookup table LUT3 stored in the storage device 304 is modified to accommodate the OS information. The display device 305 is configured to display the connection status between the keyboard 30 and the multiple hosts 221-224, such that the user can easily know the current connection status.

The storage device 304 further stores multiple OS ID codes. Each host code in the lookup table LUT3 is corresponding to one of the OS ID codes, one of the device ID codes, and one of the device authorization codes. The OS selection device 303 is configured to select one of the OS ID codes as a candidate OS ID code. The keyboard 30 determines the candidate host 223 according to the candidate OS and the candidate host code, and the communication device 308 transmits a corresponding key code according to the candidate OS to enable the keyboard 30 to control the candidate host 223. The OS ID codes to be selected may include iOS, Android, Windows, and the like. Different OS has different key codes. An example lookup table LUT3 is shown in Table 2 below.

TABLE 2

| | | | | Device |
|---|---|---|---|---|
| | Host | | Device ID | Authorization |
| | Code | OS ID Code | Code | Code |
| Host 221 | #1 | iOS | ABC | 1111 |
| Host 222 | #2 | Android | XXX | 2222 |
| Host 223 | #3 | Windows | YYY | 3000 |
| Host 224 | #4 | Android | ZZZ | 4567 |

The control method of the keyboard 30 is similar to that of the keyboard 20. The switching connection operation or the pairing operation starts only after the connection device 306 has been triggered. The difference to the control method of the keyboard 20 lies in: the user may select the target host to be controlled by triggering the OS selection device 303. The keyboard 30 then identifies the device ID code and the device authorization code of the target host in the lookup table LUT3 according to the candidate OS ID code to facilitate wireless connection.

The OS selection device 303 may be implemented by the examples shown in FIG. 4A-FIG. 4D, and thus is not repeated here. Because the communication device 308 transmits Bluetooth control signal only after the connection device 306 has been triggered, there may be possible conflict between the selected host (specified by the host selection device 302) and the selected OS (specified by the OS selection device 303) due to user's unintentional touch operation or accidental mistake operation. For example, the host selection device 302 specifies the host code #1, while the OS selection device 303 specifies Android system. A conflict occurs because the host code #1 and the Android system do not correspond to the same host in the lookup table LUT3. In one embodiment, if the connection device 306 is triggered in this situation, the method determines the target connection host according to the last triggered selection device. In other words, the order in which the host selection device 302 and the OS selection device 303 are triggered affects the selected target host. The last triggered selection device determines which data field is read from the lookup table LUT3. This approach is just exemplary rather than limiting, there may also be other control methods to resolve this kind of conflict situation. Some example approaches include: determine based the first triggered selection device, prioritize the host selection device 302, prioritize the OS selection device 303, and so on.

The display device 305 is configured to display the connection status between the keyboard 30 and the multiple hosts 221-224. As such, even if the user forgets the current connection status, or the user is away from the keyboard for a while, the user still can immediately know the current connection status from the display device 305. The display device 305 may include multiple indication lights, which are corresponding to the hosts 221-224 respectively. After the keyboard 30 connects to the candidate host 223, the indication light corresponding to the candidate host 223 is turned on. Therefore the user may know which host the keyboard is currently connected to from the indication lights. In one embodiment, the display device 305 may be a flashing indication light. The number of flashing times of the flashing indication light is corresponding to a numerical code of the candidate host 223 currently being connected to the keyboard 30. For example, the candidate host 223 is corresponding to the host code #3, the flashing indication light flashes 3 times such that the user can know the keyboard 30 is currently connected to the candidate host 223. In one embodiment, the display device 305 may display the connection status when the user triggers the connection device 306. In another embodiment, the display device 305 may continuously display the connection status.

Furthermore, as described above, there may be possible conflict between the target host specified by the host selection device 302 and the target host specified by the OS selection device 303. In this situation, the display device 305 may be configured to display at least one host that is a legal connection target among the hosts 221-224. According to the example described above, when the host selection device 302 specifies the host code #1, while the OS selection device 303 specifies Android system, the display device 305 may display legal connection target hosts for Android system. Please refer to Table 2, legal connection target hosts for Android system include the host codes #2 and #4. Thus the indication lights corresponding to the host codes #2 and #4 are turned on to inform the user the conflict situation, and to prompt the user to make a further choice.

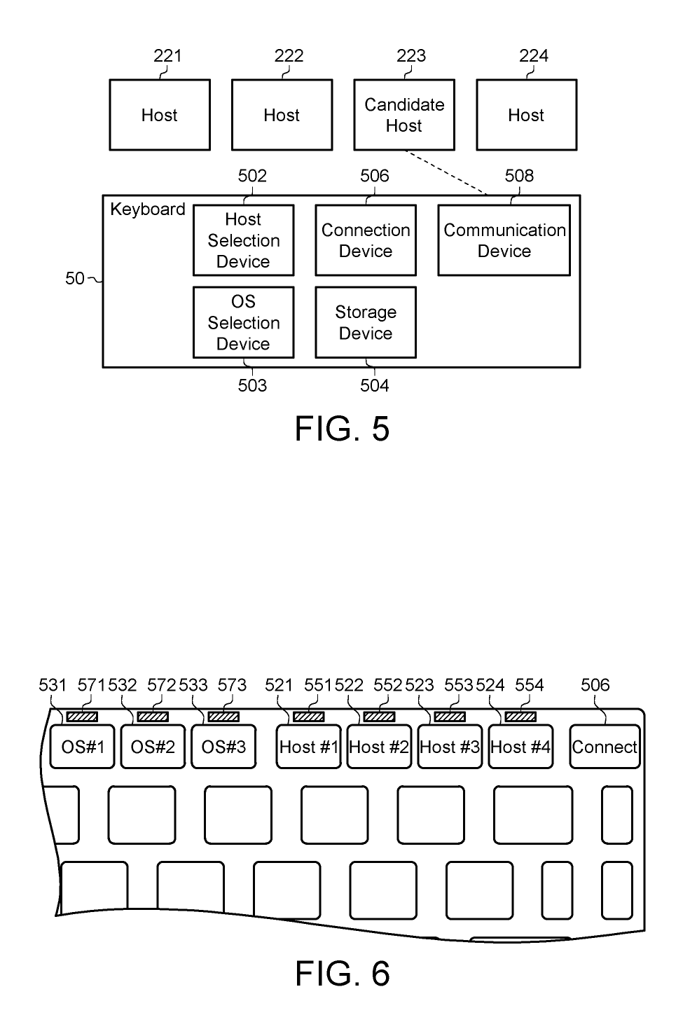

Another embodiment of the invention is given below. FIG. 5 shows a diagram of a keyboard 50 according to an embodiment of the invention. The keyboard 50 is capable of wirelessly connecting to one of multiple hosts 221-224. Each host has a device ID code and a device authorization code, and executes an OS. The keyboard 50 includes multiple host selection keys 502, multiple OS selection keys 503, a storage device 504, a connection device 506, and a communication device 508. The storage device 504 stores a lookup table LUT3, wherein the lookup table LUT3 includes multiple host code. Each host code is corresponding to one of the OS ID codes, one of the device ID codes, and one of the device authorization codes. One example of the lookup table LUT3 may be referred to Table 2. The host selection keys 502 select one of the host codes as a candidate host code, and one of the hosts 221-224, whose device ID code and device authorization code corresponding to the candidate host code, being designated as a candidate host 223. The OS selection keys select one of the OS ID codes as a candidate OS ID code. The communication device 508 is capable of wirelessly connecting the keyboard 50 to the candidate host 223. When one of the host selection keys 502 is first triggered and then the connection device 506 is triggered next, the keyboard 50 wirelessly connects to one of the hosts 221-224 having the device ID code and the device authorization code corresponding to the candidate host code. When one of the OS selection keys 503 is first triggered and then the connection device 506 is triggered next, the keyboard 50 wirelessly connects to one of the hosts 221-224 having the device ID code and the device authorization code corresponding to the candidate OS ID code.

The operations of the storage device 504, the connection device 506, and the communication device 508 are similar to those in the keyboard 20 and in the keyboard 30, and thus are not repeated here. For example, when the connection device 506 is triggered long enough, the pairing operation is then enabled. The main difference between the control method of the keyboard 50 and the control method in the previous embodiments is that, the connection target is determined according to the last triggered selection key before the connection device 506 is triggered. If the host selection key 502 is first triggered and then the connection device 506 is triggered next, connection is performed according to the host specified by the host selection key 502. If the OS selection key 503 is first triggered and then the connection device 506 is triggered next, a candidate host code is read from the lookup table LUT3 according to the candidate OS ID code specified by the OS selection key 503, and then connection is performed according to the newly determined candidate host code. For example, when the OS selection key 503 specifies iOS, and then the connection device 506 is triggered immediately after the OS selection key 503 is triggered, even if the host selection key 502 currently specifies the host code #2, the host code will be updated to #1 because of the selected iOS and the lookup table LUT3. The keyboard 50 is then connected to the host 221.

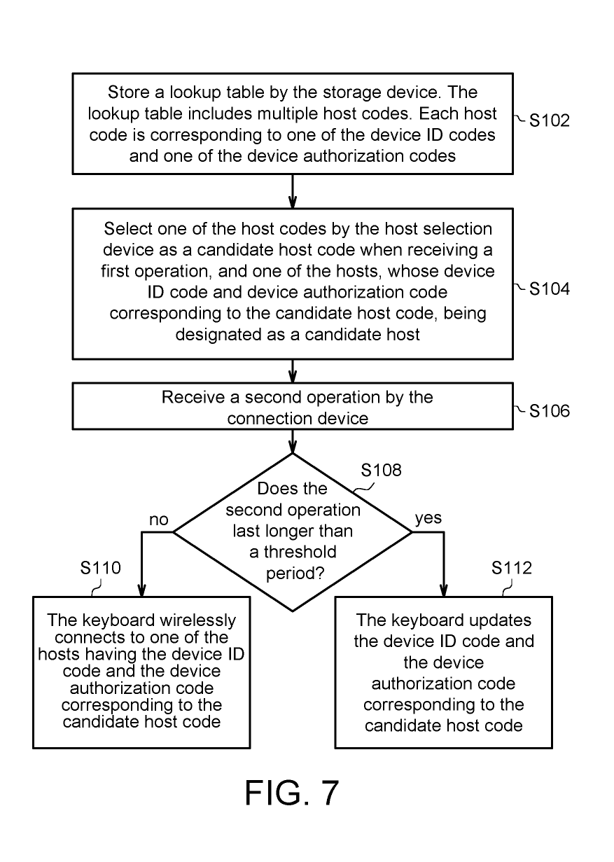

As shown in FIG. 6, the keyboard 50 may further include multiple host indication lights 551-554 and multiple OS indication lights 571-573. The host indication lights 551-554 are corresponding to the host selection keys 521-524 respectively. The OS indication lights 571-573 are corresponding to the OS selection keys 531-533 respectively. The “Connect” key in the top right corner of FIG. 6 is the connection device 506.

When one of the host selection keys 502, such as key 523, is first triggered and then the connection device 506 is triggered next, the keyboard 50 turns on the host indication light 553 corresponding to the triggered host selection key 523. The user can know the connection status between the keyboard 50 and multiple hosts 221-224 from the host indication lights 551-554. Furthermore, the keyboard 50 may update the candidate OS ID code to an OS ID code corresponding to the candidate host code in the lookup table LUT3 and turns on the OS indication light corresponding to the updated candidate OS ID code. In the above example, the OS ID code corresponding to the candidate host 223 in the lookup table LUT3 is Windows. The candidate OS ID code is updated to Windows, and the OS indication light corresponding to Windows is turned on. For example, OS #1 on the OS selection key 531 is corresponding to Windows, then the OS indication light 571 is turned on. The user can thus clearly know the OS of the host that is currently being connected to the keyboard 50.

In another embodiment, when one of the OS selection keys 503, such as key 532, is first triggered and then the connection device 506 is triggered next, the keyboard 50 turns on the OS indication light 572 corresponding to the triggered OS selection key 532. The user can know the OS that is currently being controlled by the keyboard 50 from the OS indication lights 571-573. Furthermore, the keyboard 50 may update the candidate host code to a host code corresponding to the candidate OS ID code in the lookup table LUT3 and turns on the host indication light corresponding to the updated candidate host code. In the above example, the OS ID code is for example iOS, corresponding to the host code #1 in the lookup table LUT3. The candidate host code is then updated to #1, and the host indication light 551 corresponding to the host code #1 is turned on. The user can thus clearly know which host the keyboard is currently connected to.

Following the above example, if the candidate OS ID code is Android, there will be more than one host codes corresponding to Android in the lookup table LUT3, including the host codes #2 and #4. In this situation, the keyboard 50 turns on more than one host indication lights (including host indication lights 552 and 554) corresponding to the more than one host codes corresponding to the candidate OS ID code (Android). The user can thus know the currently selected OS is corresponding to more than one hosts. The user is then prompted to further choose one of them, that is, press one of the host selection key 522 and host selection key 524. After that, the connection device 506 may be triggered to initiate connection.

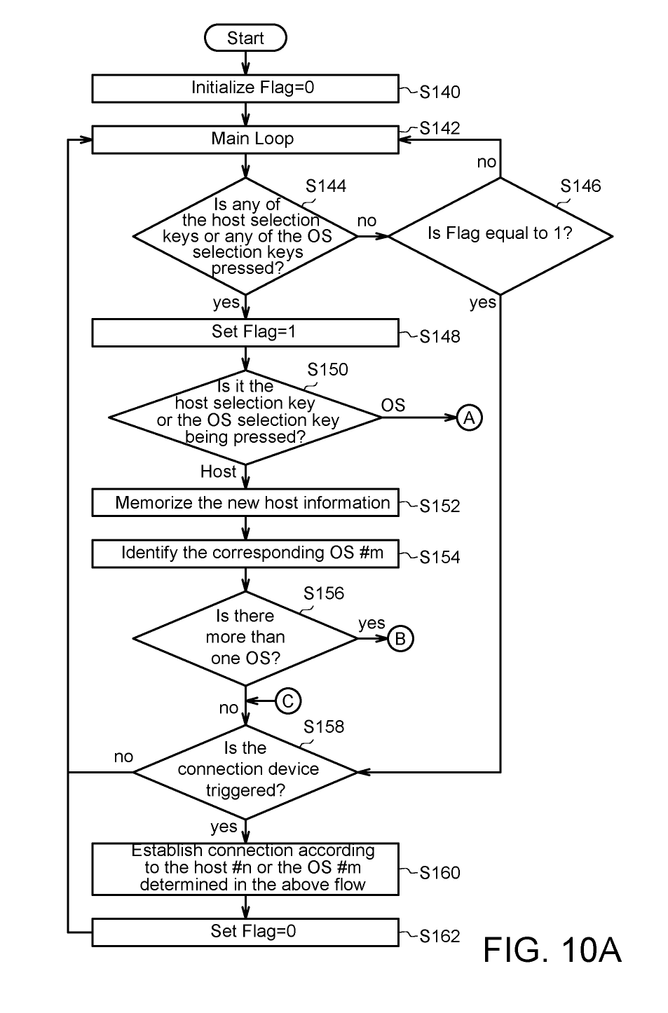

The control method of the keyboard 50 may be referred to FIG. 9. The control method includes the following steps. Step S202: Store a lookup table by the storage device. The lookup table includes multiple host codes. Each host code is corresponding to one of the OS ID codes, one of the device ID codes, and one of the device authorization codes. Step S206: Select one of the host codes as a candidate host code, and one of the hosts, whose device ID code and device authorization code corresponding to the candidate host code, being designated as a candidate host AND/OR Select one of the OS ID codes as a candidate OS ID code. Possible scenarios of the step S206 may include: select the host first and then select the OS, select the OS first and then select the host, only select the host, and only select the OS.

Step S208: Determine whether the last triggered device before the connection device being triggered is the host selection key or the OS selection key. That is, determine whether the scenario is: one of the host selection keys 502 is first triggered and then the connection device 506 is triggered next, or one of the OS selection keys 503 is first triggered and then the connection device 506 is triggered next. If the determination result of the step S208 is the host selection key, step S210 is performed. Step S210: The keyboard wirelessly connects to one of the hosts having the device ID code and the device authorization code corresponding to the candidate host code. If the determination result of the step S208 is the OS selection key, step S212 is performed. Step S212: The keyboard wirelessly connects to one of the hosts having the device ID code and the device authorization code corresponding to the candidate OS ID code.

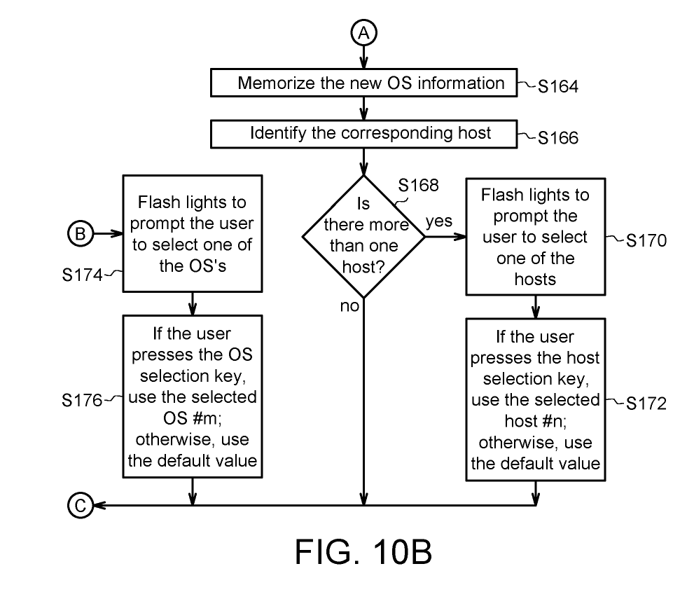

Regarding the multiple host selection keys 502 and the multiple OS selection keys 503, FIG. 10A and FIG. 10B show flowcharts of a keyboard control method according to an embodiment of the invention. The keyboard 50 has a Flag indicating the internal control state. In step S140, Flag is initialized to 0. Step S142 is the main loop, which is a loop for normal control flow when the keyboard 50 is operated in a normal condition. Step S144 determines whether or not any of the host selection keys or any of the OS selection keys is pressed. If not, step S146 is performed to check the Flag value. If yes, step S148 is performed to set Flag to 1. Next, step S150 determines whether the last triggered key is the host selection key or the OS selection key is pressed. The step S150 may be referred to the operating principle of the flowchart shown in FIG. 9. If the last pressed key is the host selection key, step S152 is performed to memorize the new host information. Step S154 identifies the OS #m corresponding to the selected host. Step S156 determines whether or not the number of the corresponding OS's is more than one. For example, because there may be certain electronic devices installed with two operating systems, after the host is selected, there may be two corresponding operating systems that need to be further specified. If the determination result of step S156 is no, there is only one OS, after the connection device is triggered (step S158), the keyboard connects to the selected host (step S160) and Flag is set to 0 (step S162), which is similar to the embodiment shown in FIG. 8.

If the determination result of step S156 is yes, there are more than one corresponding operating systems, and thus further processing is required. Refer to the node B in FIG. 10B, step S174 is performed to flash indication lights corresponding to the more than one matching OS's. The flashing indication lights prompt the user to select one of the OS's. Next, step S176 is performed, based on the further choice made by the user, or based on a default rule (such as the first matching OS in the lookup table), the connection steps in steps S158-S162 are then executed. In a scenario where the selected host has multiple OS's and the user does not clearly select the OS, the control method disclosed herein is able to inform the user which OS options are appropriate and prompt the user to make a further choice.

If the last pressed key is the OS selection key in the step S150, referring to the node A in FIG. 10B, step S164 is performed to memorize the new OS information, and step S166 is performed to identify the host #n corresponding to the OS. Step S168 determines whether or not the number of hosts corresponding to the OS is more than one. Refer to the example shown in Table 2, Android system is corresponding to two hosts, and thus further choice is required. If the determination result of step S168 is no, the flow goes back to the node C to perform the connection steps in steps S158-S162. If the determination result of step S168 is yes, step S170 is performed to flash indication lights corresponding to the more than one matching hosts. The flashing indication lights prompt the user to select one of the hosts. Next, step S172 is performed, based on the further choice made by the user, or based on a default rule (such as the first matching host in the lookup table), the flow goes back to the node C to perform the connection steps in steps S158-S162.

In the above embodiments, the user is provided with the freedom in choosing hosts and choosing OS's, making the keyboard easy for use. For example, it may be difficult for the user to memorize the exact relationship between the host codes and the actual electronic devices. Switching between multiple hosts by selecting the OS may be more close to the user's intuition. Moreover, in a scenario where there are multiple available options, a clear indication is provided to the user. For example, after the user chooses the OS, if the OS is corresponding to multiple hosts, the matching hosts that are compatible with the OS are clearly shown to the user, such that the user may make a further choice among these available options to select an appropriate host that matches the selected OS.

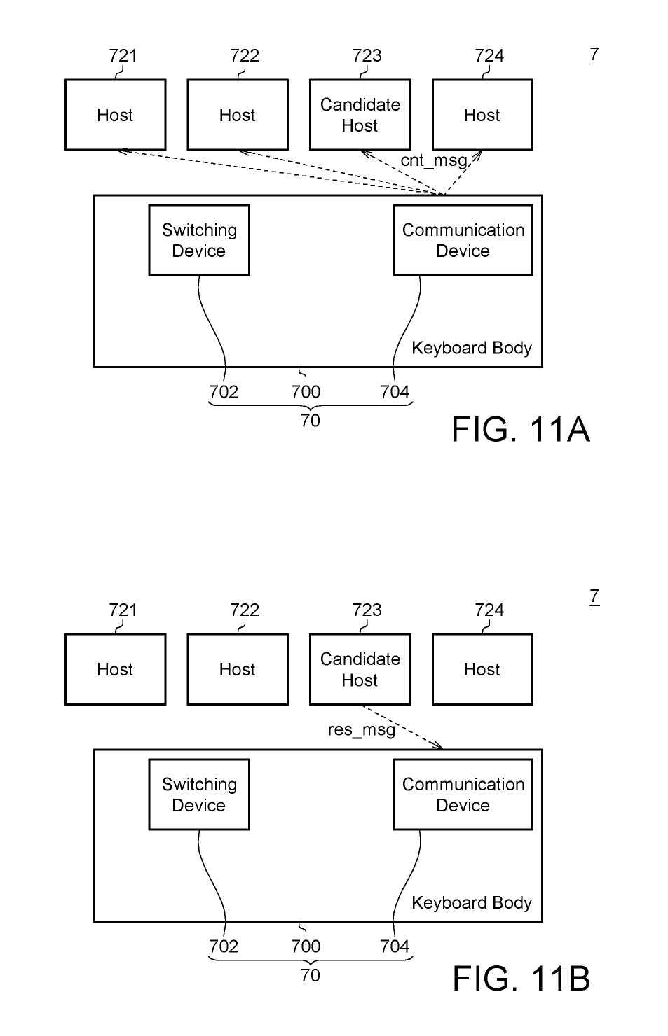

Another embodiment regarding a keyboard capable of controlling multiple hosts is provided below. As shown in FIG. 11A, the computer system 7 includes a keyboard 70 and multiple hosts 721-724. The keyboard 70 is capable of selectively connecting to one of the hosts 721-724. Each of the hosts 721-724 is capable of executing a connection response program App1. The connection response program App1 is capable of sending a connection response message res_msg in response to a user's triggering.

The keyboard 70 includes a keyboard body 700, a switching device 702, and a communication device 704. The keyboard body 700 may include a keyboard mechanical body and multiple keys, such as keys for English letters. The switching device 702 is disposed on the keyboard body 700. When the switching device 702 is triggered, the communication device 704 broadcasts a connection message cnt_msg to the multiple hosts 721-724, such that the connection response program App1 is activated to receive a user's triggering. When one of the hosts 721-724 receives the user's triggering, the host that receives the user's triggering becomes a candidate host 723 and sends the connection response message res_msg. When the communication device 704 receives the connection response message res_msg, the communication device 704 makes the keyboard 70 connect to the candidate host 723, such that the keyboard 70 is capable of transmitting data to the candidate host 723.

In this embodiment, appropriate software or application program is installed in the hosts 721-724 that are connected to the keyboard 70. As in the above example, the hosts 721-724 execute a connection response program App1. FIG. 11A shows a diagram of a keyboard 70 broadcasting connection message cnt_msg according to an embodiment of the invention. When each host 721-724 receives the connection message cnt_msg, a prompt message “Connect?” is displayed on the screen of each host 721-724. The user may directly touch on the host to confirm connection. For example, when the user wants to connect to the candidate host 723, the user may touch the host 723 to confirm the prompt message displayed thereon. FIG. 11B shows a diagram of a keyboard 70 receiving connection response message res_msg according to an embodiment of the invention. The candidate host 723 transmits the connection response message res_msg to the keyboard 70 in response to the connection message cnt_msg, and then the communication device 704 accomplishes the connection between the keyboard 70 and the candidate host 723 accordingly. Both the connection message cnt_msg and the connection response message res_msg may be transmitted through Bluetooth signal for example.

In another embodiment, when the hosts 721-724 receive the connection message cnt_msg, the hosts 721-724 are triggered to display a connection response window 750. One of the hosts 721-724 is capable of being triggered by a user to become a candidate host 723. The candidate host 723 sends the connection response message res_msg to the keyboard 70.

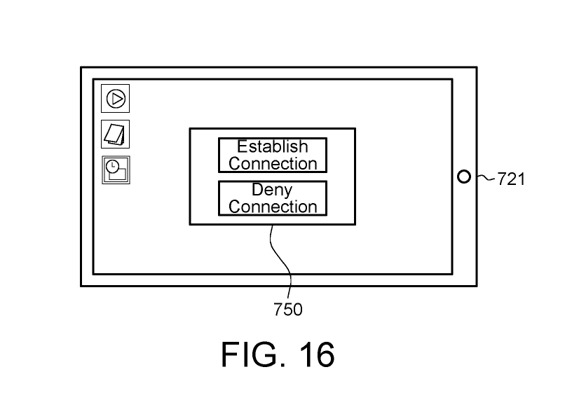

FIG. 16 shows a diagram of a connection response window 750 according to an embodiment of the invention. The host 721 is for example a tablet computer. When the host 721 receives the connection message cnt_msg, the connection response window 750 is displayed on the screen of the host 721. The connection response window 750 may include an option for “Establish Connection” and another option for “Deny Connection”. The actual wording used in each option is not restricted to the example shown in FIG. 6. The connection response window 750 enables the user to choose whether to establish connection or deny connection to the keyboard 70. After the user selects “Establish Connection”, the selected host 721 becomes the candidate host. On the other hand, after the user selects “Deny Connection”, the connection response window 750 displayed on the host 721 disappears. In this situation the host 721 is not the target host that the user wishes to connect.

In one embodiment, the connection response program App1 executed by each host 721-724 may be the same. The connection response window 750 displayed on each host 721-724 may also be the same. For example, “Establish Connection” and “Deny Connection” exist in all the connection response windows 750 on each host 721-724. After one of the hosts 721-724 has been selected to establish connection and thus has become the candidate host, the other hosts that are not selected by the user may wait for a time period and then disable the connection response window 750 to recover to the normal operation mode, without waiting for user's further selection. For example, the connection response window 750 displayed on the hosts other than the candidate host may last for a first predetermined time period T1 and then disappear. The first predetermined time period T1 may be 5 seconds or 10 seconds, which may be set appropriately depending on the actual usage.

In one embodiment, the keyboard 70 may send a message to control the hosts to stop displaying the connection response window 750, making the hosts to recover to the normal operation mode. FIG. 11C shows a diagram of a keyboard 70 broadcasting end display message end_msg according to an embodiment of the invention. In this embodiment, the host that the user wishes to connect is the candidate host 723. After the keyboard 70 receives the connection response message res_msg from the candidate host 723, the communication device 704 may broadcast an end display message end_msg. After each host 721-724 receives the end display message end_msg, the connection response window 750 displayed on the hosts other than the candidate host (hosts 721, 722, 724) will disappear. That is, when the user selects to establish connection from the screen of the candidate host 723, the keyboard 70 may inform the other hosts 721, 722, 724 to recover to the normal operation mode as soon as possible, without waiting for the user's further choice.

The keyboard 70 may further include a display device, for displaying the connection status between the keyboard 70 and the hosts 721-724. The display device may be implemented by multiple indication lights which are corresponding to the hosts 721-724 respectively, or a flashing indication lights, with the number of flashing times indicating the connected host. The display device showing the connection status has been described in the previous embodiments and thus is not repeated here.

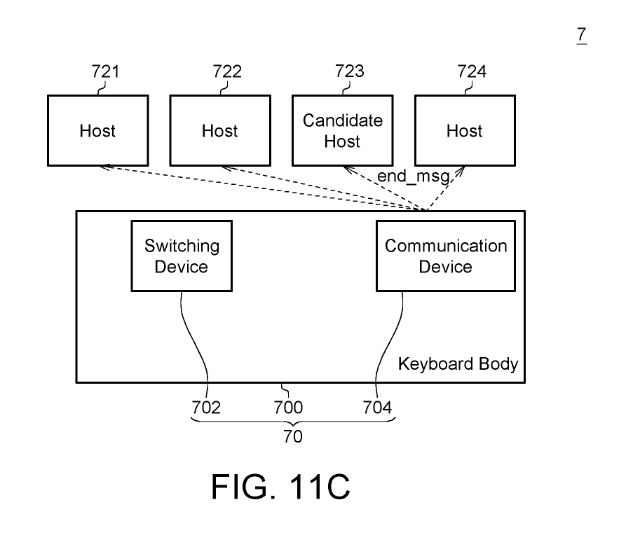

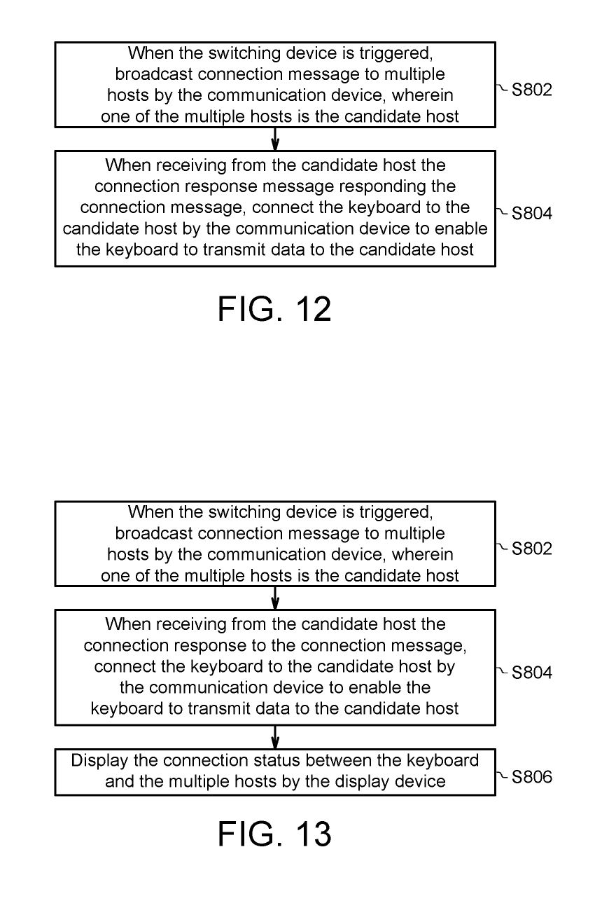

The flowchart of the control method regarding the keyboard 70 may be referred to FIG. 12. The control method includes the following steps. Step S802: When the switching device is triggered, broadcast connection message cnt_msg to multiple hosts by the communication device, wherein one of the multiple hosts is the candidate host that will be triggered by the user later. Step S804: When receiving from the candidate host the connection response message res_msg responding the connection message, connect the keyboard to the candidate host by the communication device to enable the keyboard to transmit data to the candidate host. If the keyboard 70 further includes a display device, the related control method may be referred to FIG. 13, which further includes step S806: Display the connection status between the keyboard and the multiple hosts by the display device.

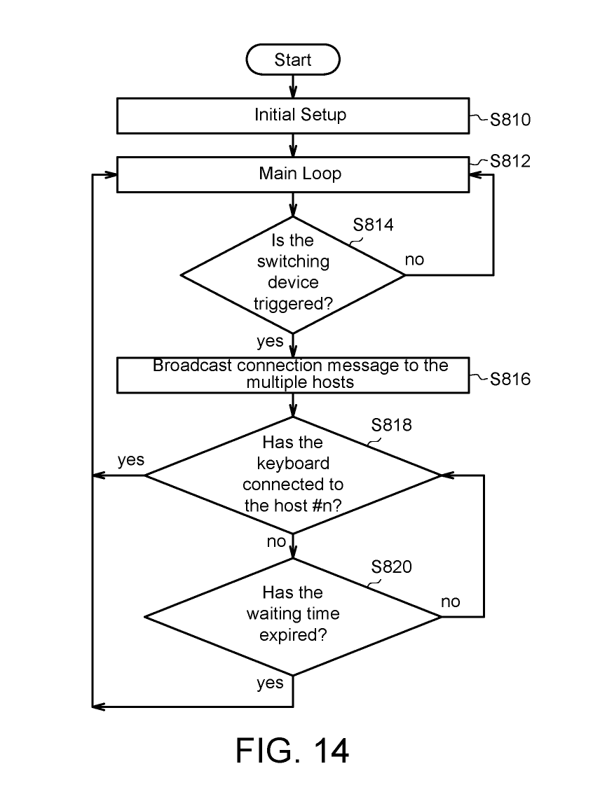

The control flow at the keyboard and at the host is individually described below. FIG. 14 shows a flowchart of a control method at the keyboard according to an embodiment of the invention. First, step S810 runs the initial setup for the keyboard. Next, step S812 runs the main loop under normal operation condition of the keyboard. Step S814 determines whether the switching device is triggered or not. If not, the control flow goes back to the main loop in step S812. If yes, step S816 is performed to broadcast connection message cnt_msg to the multiple hosts. That is, the user has decided to perform switching operation, but the target connection host has not been specified yet. Step S818 determines whether or not the keyboard has connected to one of the hosts #n. Step S820 determines whether or not the waiting time has expired. The waiting time may be related to the first predetermined time period T1 as described above. These two steps represent waiting a connection response message res_msg from a candidate host. The connection may be established as soon as the connection response message res_msg has been received. On the other hand, if the waiting time has expired and the connection response message res_msg is still not received, the control flow goes back to the main loop in step S812.

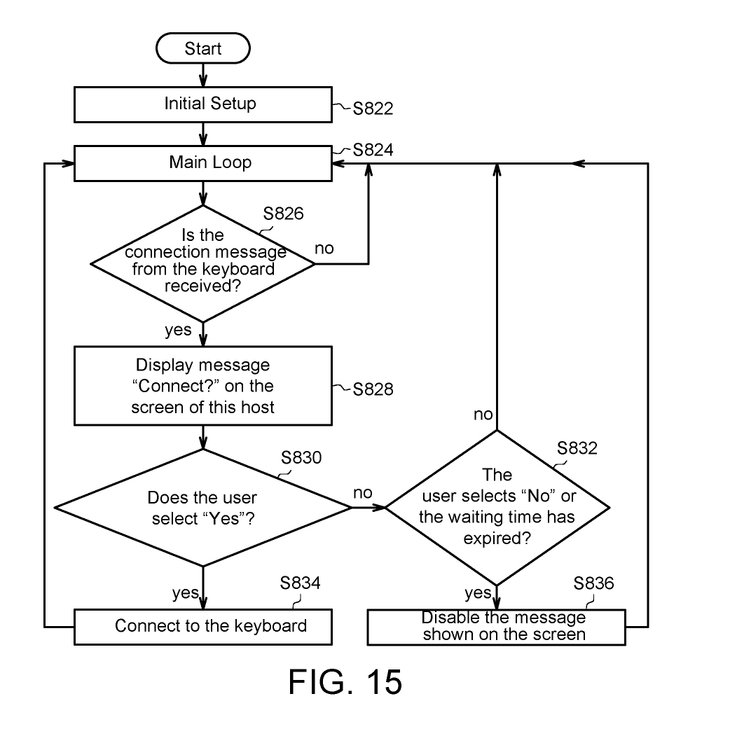

FIG. 15 shows a flowchart of a control method at the host according to an embodiment of the invention. First, step S822 runs the initial setup for the host. Next, step S824 runs the main loop under the normal operation condition of the host. Step S826 determines whether or not the connection message cnt_msg from the keyboard is received. If not, the control flow goes back to step S824. If yes, step S828 is performed to display message “Connect?” on the screen of this host. The message prompts the user to select a host to connect. There may be multiple hosts executing the control flow shown in FIG. 15 simultaneously. All these hosts display message “Connect?” on the screen when receiving the connection message cnt_msg from the keyboard. As described in the previous embodiment, each host may also display a connection response window including two options “Establish Connection” and “Deny Connection”. The following steps may be performed according to the user's response. If the user selects this host, that is, the user selects “Yes” or “Establish Connection” (step S830), step S834 is performed to connect to the keyboard. If the user does not select this host, that is, the user selects “No” or “Deny Connection”, or if the waiting time (such as the first predetermined time period T1) has expired (step S832), step S836 is performed to disable the message shown on the screen. The control flow then goes back to the main loop in step S824.

The keyboard 70 in this embodiment has even simpler hardware design for its exterior appearance. Only a single switching device, such as a key, is required. The switching device does not have to possess multiple selection markers or multiple available options. The switching device only has to be able to distinguish a triggered state from a non-triggered state. Consequently the hardware cost of the keyboard can be saved. In addition, a different user experience can be brought to the user. With the keyboard in this embodiment, the user does not have to select the host or the OS to connect. The user can simply trigger the switching device to indicate switching about to happen, and then confirm at the host to complete the switching operation. This operation method is even more intuitive to the user. The user does not have to memorize the exact relationship between the host codes and the hosts. The user can also clearly select the candidate host that the user wishes to control during the switching operation.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A keyboard, capable of wirelessly connecting to one of a plurality of hosts, each of the plurality of hosts having a device ID code and a device authorization code, the keyboard comprising:
a storage device, storing a lookup table comprising a plurality of host codes, each of the plurality of host codes corresponding to one of the plurality of device ID codes and one of the plurality of device authorization codes;
a host selection device, selecting one of the plurality of host codes as a candidate host code when receiving a first operation, and one of the plurality of hosts, whose device ID code and device authorization code corresponding to the candidate host code, being designated as a candidate host;
a connection device, capable of receiving a second operation, wherein the first operation is different from the second operation; and
a communication device, capable of wirelessly connecting the keyboard to the candidate host;
wherein when the second operation lasts shorter than a threshold period, the keyboard wirelessly connects to one of the plurality of hosts having the device ID code and the device authorization code corresponding to the candidate host code;
wherein when the second operation lasts longer than the threshold period, the keyboard updates the device ID code and the device authorization code corresponding to the candidate host code.

2. The keyboard according to claim 1, wherein the keyboard further comprises an operating system (OS) selection device, configured to select one of a plurality of OS's to be a candidate OS, the storage device further stores a plurality of OS ID codes, wherein the lookup table makes each of the plurality of host codes correspond to one of the plurality of OS ID codes, one of the plurality of device ID codes, and one of the plurality of device authorization codes; the keyboard determines the candidate host according to the candidate OS and the candidate host code, and the communication device transmits a corresponding key code according to the candidate OS to enable the keyboard to control the candidate host.

3. The keyboard according to claim 1, wherein the keyboard further comprises a plurality of indication lights, the plurality of indication lights corresponding to the plurality of hosts respectively, wherein after the keyboard connects to the candidate host, the indication light corresponding to the candidate host is turned on.

4. The keyboard according to claim 1, wherein the keyboard further comprises a flashing indication light, wherein after the keyboard connects to the candidate host, a number of flashing times of the flashing indication light is corresponding to a numerical code of the candidate host currently being connected to the keyboard.

5. The keyboard according to claim 1, wherein the host selection device and the connection device are implemented by a knob button, wherein the knob button is capable of being switched between a plurality of horizontal rotation locations, and when the knob button is pressed vertically, the connection device is triggered.

6. A keyboard, capable of wirelessly connecting to one of a plurality of hosts, each of the plurality of hosts having a device ID code and a device authorization code, and executing an operating system, each operating system represented by an OS ID code, the keyboard comprising:
a storage device, storing a lookup table comprising a plurality of host codes, each of the plurality of host codes corresponding to one of the plurality of OS ID codes, one of the plurality of device ID codes, and one of the plurality of device authorization codes;
a plurality of host selection keys, selecting one of the plurality of host codes as a candidate host code, and one of the plurality of hosts, whose device ID code and device authorization code corresponding to the candidate host code, being designated as a candidate host;
a plurality of OS selection keys, selecting one of the plurality of OS ID codes as a candidate OS ID code;
a connection device; and
a communication device, capable of wirelessly connecting the keyboard to the candidate host;
wherein when one of the plurality of host selection keys is first triggered and then the connection device is triggered next, the keyboard wirelessly connects to one of the plurality of hosts having the device ID code and the device authorization code corresponding to the candidate host code;
wherein when one of the plurality of OS selection keys is first triggered and then the connection device is triggered next, the keyboard wirelessly connects to one of the plurality of hosts having the device ID code and the device authorization code corresponding to the candidate OS ID code.

7. The keyboard according to claim 6, wherein when the connection device is triggered for longer than a threshold period, the keyboard updates the OS ID code, the device ID code, and the device authorization code corresponding to the candidate host code.

8. The keyboard according to claim 6, wherein the keyboard further comprises a plurality of host indication lights and a plurality of OS indication lights, the plurality of host indication lights corresponding to the plurality of host selection keys respectively, the plurality of OS indication lights corresponding to the plurality of OS selection keys respectively;
wherein when one of the plurality of host selection keys is first triggered and then the connection device is triggered next, the keyboard turns on the host indication light corresponding to the triggered host selection key.

9. The keyboard according to claim 8, wherein the keyboard further updates the candidate OS ID code to an OS ID code corresponding to the candidate host code in the lookup table and turns on the OS indication light corresponding to the updated candidate OS ID code.

10. The keyboard according to claim 6, wherein the keyboard further comprises a plurality of host indication lights and a plurality of OS indication lights, the plurality of host indication lights corresponding to the plurality of host selection keys respectively, the plurality of OS indication lights corresponding to the plurality of OS selection keys respectively;
wherein when one of the plurality of OS selection keys is first triggered and then the connection device is triggered next, the keyboard turns on the OS indication light corresponding to the triggered OS selection key.

11. The keyboard according to claim 10, wherein the keyboard further updates the candidate host code to a host code corresponding to the candidate OS ID code in the lookup table and turns on the host indication light corresponding to the updated candidate host code.

12. The keyboard according to claim 11, wherein when a number of host codes corresponding to the candidate OS ID code in the lookup table is more than one, the keyboard turns on more than one host indication lights corresponding to the more than one host codes corresponding to the candidate OS ID code.

13. A keyboard control method, comprising:
providing a keyboard, the keyboard comprising a plurality of host selection keys, a plurality of OS selection keys, a storage device, a connection device, and a communication device, the keyboard being capable of wirelessly connecting to one of a plurality of hosts, each of the plurality of hosts having a device ID code and a device authorization code, and executing an OS, each operating system represented by an OS ID code;
storing a lookup table by the storage device, wherein the lookup table comprises a plurality of host codes, each of the plurality of host codes corresponding to one of the plurality of OS ID codes, one of the plurality of device ID codes, and one of the plurality of device authorization codes;
selecting, by the plurality of host selection keys, one of the plurality of host codes as a candidate host code, and one of the plurality of hosts, whose device ID code and device authorization code corresponding to the candidate host code, being designated as a candidate host;
selecting, by the plurality of OS selection keys, one of the plurality of OS ID codes as a candidate OS ID code; and
wirelessly connecting, by the communication device, the keyboard to the candidate host;
when one of the plurality of host selection keys is first triggered and then the connection device is triggered next, the keyboard wirelessly connects to one of the plurality of hosts having the device ID code and the device authorization code corresponding to the candidate host code;
when one of the plurality of OS selection keys is first triggered and then the connection device is triggered next, the keyboard wirelessly connects to one of the plurality of hosts having the device ID code and the device authorization code corresponding to the candidate OS ID code.

14. The control method according to claim 13, further comprising:
when the connection device is triggered for longer than a threshold period, updating the OS ID code, the device ID code and the device authorization code corresponding to the candidate host code.

15. The control method according to claim 13, wherein the keyboard further comprises a plurality of host indication lights and a plurality of OS indication lights, the plurality of host indication lights corresponding to the plurality of host selection keys respectively, the plurality of OS indication lights corresponding to the plurality of OS selection keys respectively;
wherein when one of the plurality of host selection keys is first triggered and then the connection device is triggered next, the host indication light corresponding to the triggered host selection key is turned on;
wherein when one of the plurality of OS selection keys is first triggered and then the connection device is triggered next, the OS indication light corresponding to the triggered OS selection key is turned on.

16. The control method according to claim 15, further comprising:
updating the candidate OS ID code to an OS ID code corresponding to the candidate host code in the lookup table; and
turning on the OS indication light corresponding to the updated candidate OS ID code.

17. The control method according to claim 15, further comprising:
updating the candidate host code to a host code corresponding to the candidate OS ID code in the lookup table; and
turning on the host indication light corresponding to the updated candidate host code.

18. The control method according to claim 17, wherein when a number of host codes corresponding to the candidate OS ID code in the lookup table is more than one, more than one host indication lights corresponding to the more than one host codes corresponding to the candidate OS ID code are turned on.
